(19) United States
(12) Patent Application Publication
(10) Pub. No.: US 2025/0342994 A1
(43) Pub. Date: Nov. 6, 2025

(54) LIQUID NEON (LNE) THERMOSIPHON COOLING SYSTEM FOR HIGH TEMPERATURE SUPERCONDUCTING (HTS) MAGNETS

(71) Applicant: Canyon Magnet Energy Inc., East Setauket, NY (US)

(72) Inventors: Steven W. Van Sciver, Haymarket, VA (US); Youri Viochkov, Tallahassee, FL (US); Honghai Song, East Setauket, NY (US)

(73) Assignee: Canyon Magnet Energy Inc., East Setauket, NY (US)

(21) Appl. No.: 19/198,167

(22) Filed: May 5, 2025

Related U.S. Application Data
(60) Provisional application No. 63/641,955, filed on May 3, 2024.

(51) Int. Cl. H01F 6/04; H01F 6/06

(52) U.S. Cl. CPC H01F 6/04; H01F 6/06

(57) ABSTRACT

A liquid neon (LNe) thermosiphon system for cooling a high-temperature superconducting (HTS) magnet is disclosed. The system may include a phase separator vacuum vessel enclosing a cryocooler, a heat exchanger, and a phase separator configured to condense circulating neon gas into liquid phase. A thermosiphon circuit comprising a LNe supply line, return line, and one or more coil cooling lines circulates the liquid neon to and from the HTS coil and associated magnet current leads. The circulation is driven passively by the thermal load of the HTS magnet, enabling heat to be removed without mechanical pumps. The coil is housed within a vacuum-insulated coil vessel to minimize thermal losses. The vertical orientation of the HTS coil allows gravitational assistance in the return flow of cryogen, optimizing system performance. This compact and pressure-tolerant design facilitates integration in superconducting systems implementing efficient and stable cryogenic cooling.

### CROSS-REFERENCE TO RELATED APPLICATIONS

This application is a U.S. Non-Provisional Utility patent application which claims priority to co-pending U.S. Provisional Patent Application No. 63/641,955, filed on May 3, 2024, the contents of which are hereby fully incorporated by reference.

### FIELD

This invention relates to systems and methods for cooling high temperature superconducting (HTS) magnets. M ore precisely, it introduces a HTS magnet system implementing a thermosiphon based on two-phase liquid neon (LNe) configured for cooling one or more HTS magnets.

### BACKGROUND

A HTS magnet is a type of magnet that utilizes materials exhibiting superconductivity at relatively high temperatures. These magnets can generate strong magnetic fields and are used in various applications such as magnetic resonance imaging (MRI) machines, particle accelerators, and magnetic fusion systems. HTS magnets used in applications such as magnetic fusion can experience heating due to several factors. Firstly, despite their name, HTS materials still require cooling to temperatures below room temperature to maintain superconductivity. If the temperature rises above a predetermined level, the material loses its superconducting properties, leading to a sudden increase in resistance and the generation of heat. This process is known as quenching. Secondly, even in the superconducting state, there is still some energy dissipation as current flows through the material, resulting in heat production due to imperfections or flux pinning effects. Thirdly, operational conditions in fusion applications, including intense magnetic fields, high currents, and harsh environmental factors like elevated temperatures and radiation, can contribute to heat generation within the magnet system. Management of heat is utilized for stable and efficient operation of HTS magnets and requires the implementation of cooling systems to remove excess heat and maintain the superconducting state of the material.

A current problem with existing methods for cooling HTS magnets is the energy consumption and complexity of the cooling systems required to cool down and maintain the superconducting state of the material. Traditionally, HTS magnets are cooled using cryogenic systems, typically with liquid or gaseous helium. While these cooling methods may reach the necessary temperatures for superconductivity, they can be energy-intensive, slow to reach operating temperature and expensive to maintain. Helium, in particular, may be costly and may present logistical challenges in terms of supply and handling. Furthermore, the cooling systems themselves can be complex and bulky, especially for large-scale applications such as fusion machines and/or particle accelerators and for some specialized applications rapid cooldown is required. Minimizing the size and energy consumption of these cooling systems while still providing efficient cooling is a significant challenge in the development of HTS magnet technology. It is more desirable to have a more efficient and cost-effective cooling method for HTS magnets to address these challenges and make HTS technology more practical and widely applicable.

### SUMMARY

The present innovation seeks to overcome the limitations of current methods for cooling HTS magnets by offering a system with a thermosiphon utilizing two-phase LNe configured for cooling high-temperature superconducting (HTS) magnets. LNe, with a higher normal boiling point at atmospheric pressure (27 K), surpasses liquid helium (LHe) at 4.2 K in this regard. Operating at 27 K offers distinct advantages for HTS magnets, as they can achieve higher magnetic fields compared to those based on low-temperature superconducting materials (such as NbTi and Nb3Sn) operating at 4.2 K. Furthermore, employing LNe cooling provides several specific advantages over LHe cooling. Firstly, operating a magnet system at 27 K instead of 4.2 K significantly reduces the room temperature refrigeration power requirement due to the enhanced efficiency of the refrigeration system. Secondly, LNe possesses a much higher heat of vaporization per unit volume compared to liquid helium, approximately 100 kJ/liter versus 2.5 kJ/liter, respectively. Consequently, a thermosiphon of the same size could sustain a heat load approximately 40 times higher than a similar liquid helium thermosiphon. The high heat of vaporization of LNe also provides the opportunity to rapidly cool an HTS magnet by using the stored cryogen rather than the refrigeration system to bring the magnet to operating temperature. Lastly, due to its higher heat of vaporization, a neon thermosiphon can remove comparable heat loads in a more compact manner compared to a helium thermosiphon, potentially enabling a more volume and cost-efficient HTS magnet system.

As noted above, thermosiphons may be implemented for heat transfer in superconducting magnet technology. In an example, liquid helium thermosiphons may be configured for cooling large superconducting detector magnets and managing distributed heat loads while minimizing the liquid helium inventory necessary for operation. Moreover, these thermosiphons may be integrated into magnetic resonance imaging (MRI) magnets, facilitating fully contained cryogenic systems that eliminate the need for periodic liquid helium refills. Central to the functionality of all thermosiphons are several key features. Firstly, they incorporate a self-contained fluid handling system, typically featuring a partially filled liquid-vapor phase separator positioned at the highest point. A gravity-fed supply line, situated at the bottom of the phase separator, delivers liquid to the lowest point on the thermal load, ensuring uninterrupted liquid flow without direct contact with the load. Parallel return lines, in contact with the thermal load, absorb heat and generate a two-phase (liquid-vapor) mixture, facilitating its natural circulation back to the phase separator. Lastly, an integral refrigeration system, thermally coupled with the phase separator, supplies sufficient cooling power to re-condense the returning vapor fraction of the two-phase mixture, thereby sustaining a steady flow within the thermosiphon system.

In some aspects, the techniques described herein relate to a liquid neon thermosiphon system for cooling a HTS magnet, including: a phase separator vacuum vessel, including: a cryocooler; a heat exchanger thermally coupled to the cryocooler; and a phase separator configured to receive neon vapor and condense it into liquid neon; and a thermosiphon circuit configured to circulate liquid neon, driven by a thermal load from one or more HTS coils and associated current leads, the thermosiphon circuit including: a LNe supply line; a coil cooling line; and a return line configured to direct vaporized neon to the phase separator.

In some aspects, the techniques described herein relate to a toroidal LNe thermosiphon system for cooling a toroidal HTS magnet assembly, including: a plurality of HTS coils arranged circumferentially within a vacuum enclosure; a plurality of phase separators, each associated with a respective HTS coil and including: a helium-cooled heat exchanger; and a local neon phase separator; a centralized helium gas refrigerator configured to deliver helium gas at approximately 25 K to the heat exchanger; and for each HTS coil, a thermosiphon circuit including: a liquid neon supply line; a coil cooling line; and a return line directed to an associated phase separator.

In some aspects, the techniques described herein relate to a base-mounted LNe thermosiphon system for a horizontal HTS magnet, including: a horizontal HTS coil enclosed within a vacuum vessel; a cryocooler mounted on a support structure; a phase separator vacuum vessel thermally coupled to the cryocooler; a liquid neon thermosiphon circuit connecting the phase separator to the coil; and a base support configured provide vibration isolation and mechanical alignment between the phase separator vacuum vessel, the cryocooler, and the horizontal HTS coil.

In some aspects, the techniques described herein relate to a hybrid magnet cooling system, including: a liquid nitrogen (LN₂) subsystem including a reservoir thermally coupled to an HTS coil, the LN₂ subsystem configured to precool the HTS magnet from approximately 300 K to approximately 80 K; a liquid neon (LNe) thermosiphon system including: a phase separator vacuum vessel including a cryocooler, a heat exchanger, and a liquid neon phase separator of sufficient volume to cool the HTS magnet from approximately 80 K to approximately 20 K; and a thermosiphon circuit driven by a thermal load from the HTS coil and associated current leads, the thermosiphon circuit including a liquid neon supply line and a plurality of parallel coil cooling lines.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

FIG. 1 is a diagram illustrating an example of a compact LNe thermosiphon for cooling a vertically oriented HTS magnet in accordance with some embodiments.

FIG. 2 is a diagram illustrating the compact LNe thermosiphon for cooling the vertically oriented HTS magnet of FIG. 1 with a support structure and a base plate in accordance with some embodiments.

FIG. 3 is a diagram illustrating an example of a compact LNe thermosiphon for cooling a horizontally oriented HTS magnet in accordance with some embodiments.

FIG. 4 is a diagram illustrating the compact LNe thermosiphon for cooling the horizontally oriented HTS magnet of FIG. 3 with a base in accordance with some embodiments.

FIG. 5 is a diagram illustrating an example of a compact LNe thermosiphon for cooling a toroidal HTS magnet system in accordance with some embodiments.

FIG. 6 is top plan view illustrating the compact LNe thermosiphon for cooling the toroidal HTS magnet system of FIG. 5 in accordance with some embodiments.

FIG. 7 is side cut-away view illustrating the compact LNe thermosiphon for cooling the toroidal HTS magnet system of FIG. 5 in accordance with some embodiments.

FIG. 8 is a diagram illustrating the toroidal HTS coil and phase separator of the compact LNe thermosiphon for cooling the toroidal HTS magnet system of FIG. 7 in accordance with some embodiments.

FIG. 9 is a diagram illustrating a horizontal HTS coil, LN2 reservoir and LNe phase separator for precooling a horizontal HTS magnet from 300 K to 27 K in accordance with some embodiments.

### DETAILED DESCRIPTION

It is to be understood that the figures and descriptions provided herein may have been simplified to illustrate aspects that are relevant for a clear understanding of the herein described processes, machines, manufactures, and/or compositions of matter, while eliminating, for the purpose of clarity, other aspects that may be found in typical devices, systems, and methods. Those of ordinary skill in the pertinent art may recognize that other elements and/or steps may be desirable and/or necessary to implement the devices, systems, and methods described herein. Because such elements and steps are well known in the art, and because they do not facilitate a better understanding of the present disclosure, a discussion of such elements and steps may not be provided herein. However, the present disclosure is deemed to inherently include all such elements, variations, and modifications to the described aspects that would be known to those of ordinary skill in the pertinent art.

It will be readily understood that the components of the present invention, as generally described and illustrated in the figures herein, may be realized in a variety of different configurations. Thus, the following detailed description of the embodiments of a method, apparatus, and system, as represented in the attached figures, is not intended to limit the scope of the invention as claimed, but is merely representative of selected illustrative embodiments of the invention. The usage of the phrases “example embodiments,” “some embodiments,” or other similar language, throughout this specification refers to the fact that a particular feature, structure, or characteristic described in connection with the embodiment may be included in at least one embodiment of the present invention, and do not necessarily all refer to the same group of embodiments.

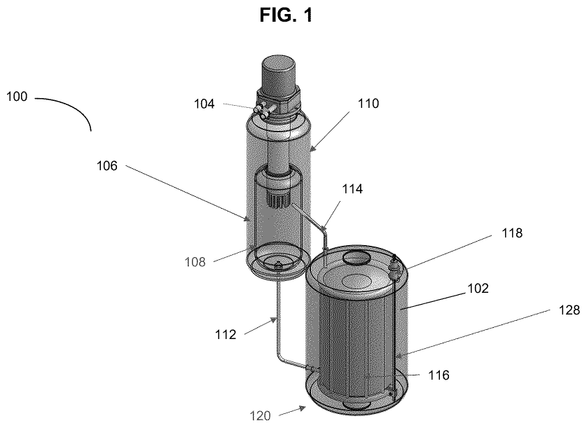

FIGS. 1-9 illustrate example configurations, structures, and processes to implement LNe thermosiphon for cooling an HTS magnet that includes a system with compact LNe thermosiphons for cooling various configurations of HTS magnets. In implementations, some of these configurations may include, but not be limited to, a vertically oriented, a horizontally oriented, and/or a toroidal HTS magnet system tailored for different applications such as research and magnetic confinement fusion. In each configuration, the cryocooler, heat exchanger, and phase separator are enclosed within a vacuum vessel, facilitating the liquefaction of neon circulating through the thermosiphon. The thermosiphon circuit consists of LNe supply and return lines, along with coil cooling lines, driven by the thermal load from the HTS coils and current leads. Additionally, in an embodiment, multiple HTS coils within the vacuum vessel are supplied in series by one power supply, with the neon liquefied within phase separators via a closed-loop stream of cold helium gas from a central refrigeration plant. Overall, these compact LNe thermosiphons offer cooling solutions for a range of HTS magnet configurations, ensuring optimal performance and longevity in various applications.

The present disclosure provides a liquid neon (LNe) thermosiphon system for cooling HTS magnets in a variety of configurations, including vertically oriented, horizontally oriented, toroidal, and hybrid rapid-cooldown systems. The system utilizes a combination of a cryocooler, heat exchanger, and a phase separator, all enclosed within a vacuum vessel, to enable passive circulation of liquid neon for efficient and compact cryogenic cooling.

The phase separator vacuum vessel includes a cryocooler, which may be a two-stage Gifford-McMahon or pulse tube refrigerator capable of maintaining sub-30 K temperatures. The cryocooler is thermally coupled to a heat exchanger, which facilitates the condensation of neon gas into liquid neon. The heat exchanger may be constructed using coiled copper tubing, finned structures, or porous sintered metal to maximize thermal transfer surface area. The liquefied neon is then circulated through a closed-loop thermosiphon circuit. The thermosiphon operates without mechanical pumps and is driven by the thermal load of the HTS coil and associated current leads. The circuit includes a liquid neon supply line that delivers cryogen to the coil region, one or more coil cooling lines in thermal contact with the superconducting windings, and a return line that allows vaporized neon to flow back into the phase separator for recondensation. This two-phase circulation enables continuous heat removal via latent heat exchange.

In one configuration, the HTS magnet is vertically oriented, with the phase separator vacuum vessel positioned at a higher elevation than the magnet housing. This elevation enables gravity-assisted return of neon vapor through the return line. The return line may be installed with a positive slope of approximately 3 to 5 degrees to prevent vapor trapping and ensure stable operation. The coil may be enclosed within a cylindrical vacuum vessel constructed from non-magnetic stainless steel, such as 316L, with integrated ports for cryogen routing, sensors, and instrumentation.

In another configuration, the HTS magnet is horizontally oriented, allowing for installation in systems that require lateral access, such as particle accelerators, beamline instruments, or imaging platforms. In these implementations, the return line may include internal wicking structures or be slightly inclined to ensure proper vapor return. The phase separator, cryocooler, and supply/return lines may be mounted on a vibration-isolated support platform. Structural alignment features may be included to preserve the thermosiphon geometry during thermal cycling.

In systems deployed for large-scale scientific or industrial applications, such as magnetic confinement fusion devices, the liquid neon thermosiphon system may be scaled up to cool large or complex HTS magnet geometries. In such applications, the vacuum vessel and phase separator may be pressure-rated to withstand up to 5 MPa to accommodate the expansion of neon gas at room temperature. The thermosiphon circuit may include thermal intercepts connected to intermediate cooling stages (e.g., at 77 K or 50 K) to minimize parasitic heat flow along the current leads and support structures. The liquid neon circulating in the thermosiphon typically operates in a two-phase regime, with both liquid and vapor present in the system during steady-state cooling. This regime enables efficient transfer of heat through vaporization and condensation cycles. The operating temperature of the HTS magnet is maintained within a range of approximately 25 K to 30 K, depending on the design and critical temperature of the superconducting material.

In another embodiment, the HTS magnet is arranged in a toroidal configuration, such as those used in compact fusion reactors, high-field NMR systems, or other annular magnet geometries. Multiple HTS coils are arranged circumferentially and housed within a nested vacuum enclosure that includes inner and outer vacuum vessels. Each coil is connected to a local phase separator that contains a helium-cooled heat exchanger. A centralized helium gas refrigerator supplies helium gas at approximately 25 K to each phase separator through dedicated helium lines. The helium gas removes latent heat from the neon vapor, allowing it to condense back into liquid form. Each toroidal coil operates independently within its own closed-loop thermosiphon circuit, providing fault tolerance and modularity. In some implementations, the helium cooling loops are shared between adjacent coils to reduce system complexity. Sensors such as temperature probes, voltage taps, and quench detection circuits may be embedded near each coil. The vacuum vessels may include multilayer insulation, cryo-pumping surfaces, and getter materials such as non-evaporable getter (NEG) cartridges or titanium-coated panels to maintain ultra-high vacuum (UHV) levels between approximately 10⁻⁶ Torr and 10⁻⁹ Torr during long-term operation. A hybrid system may also be implemented to enable rapid cool-down from ambient temperature. In this configuration, a liquid nitrogen (LN₂) reservoir is thermally coupled to the HTS magnet and is used to precool the system from approximately 300 K to approximately 80 K. Once precooling is complete, the LN₂ is removed or isolated, and the LNe thermosiphon is activated to bring the temperature down to the target operational range below about 30 K. The phase separator in this hybrid configuration is sized to hold sufficient neon to absorb the remaining thermal energy and complete the cooldown to cryogenic operating conditions. This architecture allows for faster commissioning and reduces load on the cryocooler.

Across all configurations, the system may incorporate modular vacuum vessels, flexible cryogenic plumbing, and integrated alignment supports. The coil cooling lines may use parallel flow tubes connected by upper and lower manifolds to distribute LNe uniformly around the coil windings. The design supports integration into compact cryostats, magnet platforms, or experimental setups requiring stable low-temperature operation with minimal thermal losses. The described LNe thermosiphon systems are suitable for a range of HTS magnet applications, including laboratory-scale research, medical imaging, industrial superconductivity, and large-scale fusion energy systems. The passive cooling architecture, combined with modular hardware design, enables long-term reliability, ease of maintenance, and improved cryogenic efficiency across various use cases.

FIG. 1 illustrates an example of vertical HTS coil with LNe thermosiphon. In some embodiments, a compact LNe thermosiphon 100 is configured for cooling a vertically oriented HTS magnet 102. The cryocooler 104, heat exchanger 106, and phase separator 108 are enclosed within the attached phase separator vacuum vessel 110. These components may facilitate the liquefaction of neon (not shown) circulating through the thermosiphon. A LNe supply line 112, a LNe return line 114, and a LNe HTS coil cooling line 116 may be included in the thermosiphon circuit, which is propelled by the thermal load from a vertical HTS coil 128 and one or more magnet current leads 118. The system allows for a warm bore superconducting magnet with vertical access, necessitating the cryocooler to fit within the cryostat up to the top flange. Typically, the size of the LNe phase separator may appear larger than necessary, as it is configured to accommodate approximately 1 liter of liquid (with the vessel volume totaling a few liters). However, if the intention is to include the neon gas at room temperature (300 K), the volume may expand to around about 30 liters, necessitating a pressure vessel capable of handling a maximum design pressure of approximately 5 MPa. Additionally, small diameter supply and return lines may be vacuum insulated and capable of withstanding pressures of up to 5 MPa. In some embodiments, the return line may avoid one or more horizontal sections and may be oriented in an upward slope. Return lines may be oriented to have a positive slope. The neon gas inventory may be retained outside the cryogenic environment by attaching a pressure vessel to the phase separator, albeit at the cost of compactness. The manifold and lines surrounding the magnet adopt vertical parallel tubes connected to the top and bottom manifolds.

In some example implementations, the phase separator vacuum vessel 110 may be dimensioned with an internal volume of approximately 3 to approximately 5 liters, which may accommodate about 1 liter of LNe and the gas headspace at operating conditions. For instance, when the neon gas inventory is considered at room temperature (approximately 300 K), the expanded gas volume would require a vessel capable of withstanding pressures up to about 5 MPa. In some embodiments, the LNe supply line 112 and the return line 114 may be constructed from stainless steel tubing, such as 316L stainless steel, with an inner diameter in the range of about 4 mm to about 8 mm and/or wrapped with a multilayer insulation (MLI) within a vacuum jacket to minimize thermal ingress. In some embodiments, the return line 114 is routed with a minimum positive slope of at least about 3 degrees to about 5 degrees to avoid vapor trapping and to support continuous liquid return to the phase separator 108. For compact implementations where external gas storage is avoided, the manifold surrounding the HTS coil 102 may comprise vertically oriented tubes arranged in parallel, connecting an upper manifold and a lower manifold to achieve uniform liquid distribution. Alternatively, if external neon storage is desired to simplify the phase separator vessel design, a separate high-pressure external tank may be used, albeit at the expense of system compactness. Interface components, such as the joints between the cryocooler 104 and the phase separator 108, must be rated to the same pressure specifications to ensure safe operation across all phases of the thermosiphon cycle.

The coil vacuum vessel 120 is configured to enclose the vertical HTS coil 102 and maintain a high-quality vacuum environment around the superconducting coil assembly. The phase separator vacuum vessel 110 is positioned adjacent to and vertically elevated relative to the coil vacuum vessel 120, such that gravitational potential assists in the return flow of LNe through the thermosiphon circuit. This higher placement facilitates a natural thermosiphon effect, enabling condensed LNe to flow downward via the supply line 112 into the coil vacuum vessel 120, where the vertical HTS magnet 102 is housed. The elevation difference between the vessels is a deliberate design feature to support passive, gravity-driven circulation of the cryogen without the need for mechanical pumps. This vacuum may thermally insulate the HTS magnet 102 from ambient temperatures, and reducing radiative and conductive heat transfer that would otherwise increase the thermal load on the LNe thermosiphon 100. In some embodiments, the vacuum vessel 120 may be constructed from non-magnetic stainless steel, such as 316L or 304L, to prevent interference with the magnetic field of the superconducting coil. The vessel 120 may be cylindrical in shape to allow clearance around the HTS magnet 102 for wiring, thermal shields, and/or cryogenic plumbing such as the LNe cooling lines 116.

In one example, the coil vacuum vessel 120 may have an internal diameter of approximately about 300 mm to about 500 mm and a height of about 600 mm to about 1000 mm, depending on the size and/or configuration of the HTS coil. The vessel may also include integrated feedthroughs for current leads 118, instrumentation wiring (e.g., temperature sensors, voltage taps), and/or neon cooling lines 112, 114, and 116, each sealed using vacuum-tight connectors such as CF flanges or metal-sealed feedthroughs. Additionally, the materials and/or one or more cryo-pumping surfaces may be included inside the coil vacuum vessel 120 to facilitate one or more ultra-high vacuum (UHV) levels during prolonged operation. In some embodiments, the internal pressure may be reduced and stabilized within a range of approximately 10⁻⁶ to 10⁻⁹ Torr, depending on system configuration and outgassing characteristics of the internal components. For even more stringent requirements, pressures approaching the extreme high vacuum (XHV) regime, on the order of about 10⁻¹⁰ Torr or lower, may be achievable through the use of non-evaporable getter (NEG) pumps, ion pumps, and/or cryogenic baffles in conjunction with low-outgassing materials and proper thermal shielding.

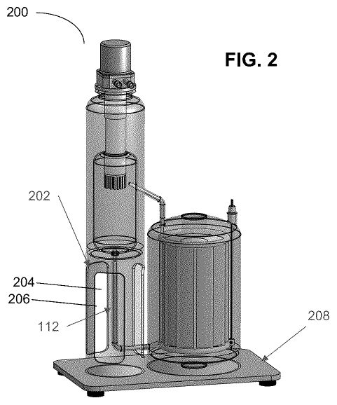

FIG. 2 illustrates an example installed system 200 implementing a Vertical HTS coil with LNe thermosiphon. In some embodiments, the compact LNe thermosiphon is configured for cooling the vertically oriented HTS magnet of FIG. 1 with a support structure 202 and a base plate 208. The support structure has one or more openings 204 bordering a compartment 206 housing the LNe supply line 112. In some embodiments, the compact LNe thermosiphon is configured to provide passive, closed-loop cooling for the vertically oriented HTS magnet 102 of FIG. 1. The HTS assembly is mounted within a support structure 202 that provides mechanical stability, thermal isolation, and alignment control during operation. The support structure 202 may be fabricated from a low-thermal-conductivity composite material (e.g., G10 fiberglass-reinforced epoxy or PEEK) to minimize heat conduction from the environment to the cryogenic components.

The support structure 202 features one or more vertical or lateral access openings 204 bordering a central compartment 206 that houses the LNe supply line 112. These openings 204 facilitate cable routing, thermal anchoring, vacuum line access, and serviceability without disturbing the surrounding structure. The compartment 206 may include brackets or clamps to secure the LNe supply line 112 in position and may be internally shielded with multilayer insulation (MLI) or reflective foil to further reduce radiative heat transfer into the cryogenic fluid path. The assembly may be anchored to a rigid base plate 208, which may be made from a thermally conductive metal including, but not limited to, aluminum and/or copper for grounding and structural support. In one example implementation, the base plate 208 is mounted to a vibration-isolated optical table or experimental platform, and may include bolt holes, fiducial markers, and/or adjustable feet for alignment and/or leveling. Thermal standoffs may also be integrated between the base plate 208 and the cryostat to decouple vibration or reduce thermal conduction from room-temperature surfaces.

In some configurations, instrumentation such as temperature sensors, magnetic field probes, and/or one or more vacuum gauges may be embedded along the support structure 202 and/or integrated into the one or more openings 204 to monitor the status of the HTS coil and cryogenic environment in real time during extended operation.

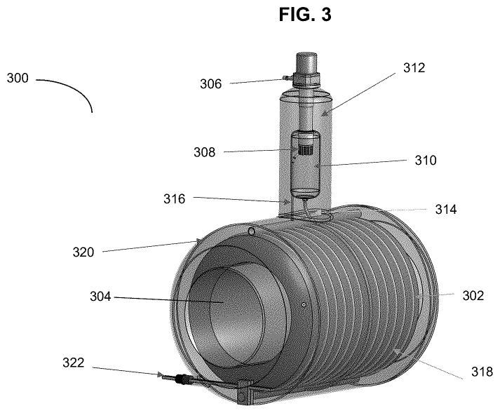

FIG. 3 is a diagram illustrating an example system including a compact LNe thermosiphon 300 for cooling a horizontally oriented HTS magnet 304, wherein cooling is applied via a horizontal HTS coil 302 thermally coupled to the magnet. The cryocooler 306, heat exchanger 308, and phase separator 310 are housed within the phase separator vacuum vessel 312. These components facilitate the liquefaction of neon circulating through the thermosiphon. The coil vacuum vessel 320 is configured to enclose the horizontal HTS coil 302 and maintain a high-quality vacuum environment around the superconducting coil assembly. Current leads 322 may be electrically and mechanically connected to the bottom manifold of the HTS coil assembly. In some embodiments, the current leads comprise two conductive rods arranged in parallel to minimize inductance and distribute current evenly. These leads may be constructed from high-conductivity materials such as copper or silver-plated copper, and may be cryogenically anchored at intermediate stages to reduce thermal conduction from room temperature to the superconducting region. The parallel configuration facilitates balanced current flow into and out of the HTS coil windings, while also allowing integration with voltage taps, thermal intercepts, or quench protection circuitry as needed for stable magnet operation. The thermosiphon circuit comprises the LNe supply line 314, return line 316, and LNe HTS coil cooling lines 318, driven by the thermal load from the HTS coil and coil current leads. This configuration enables the construction of a warm bore superconducting magnet with horizontal access, potentially allowing for larger magnets suitable for applications such as accelerator magnets. To accommodate this design, the cryocooler may be sized to fit within the cryostat up to the top flange. However, concerns arise regarding the size of the LNe phase separator, which appears larger than necessary as it may hold approximately 1 liter of liquid. However, if the volume is intended to include the neon gas at room temperature (300 K), it may expand to around 30 liters, necessitating a pressure vessel capable of withstanding a maximum design pressure of approximately 5 MPa. Additionally, small diameter supply and return lines must be vacuum insulated and capable of withstanding pressures of up to 5 MPa. In this configuration, could the components may be retained inside the vertical stack. The return line may maintain a positive slope to facilitate proper flow. The interface between the cryocooler and the phase separator also requires consideration for high-pressure compatibility. Furthermore, the design should incorporate the manifold and lines around the magnet, potentially adopting a configuration with parallel tubes resembling ribs connected to the top and bottom manifolds.

In one example implementation, the coil vacuum vessel 320 may be constructed from non-magnetic stainless steel and dimensioned to house a horizontal HTS coil with an overall length of approximately 600 mm to approximately 1000 mm and a diameter of about 100 mm to about 300 mm, depending on the magnetic field strength and application. The internal vacuum level may be maintained between about 10⁻⁶ Torr and about 10⁻⁹ Torr using a combination of turbomolecular pumping during initial evacuation and cryo-pumping during steady-state operation. The current leads 322 may incorporate thermal intercepts at intermediate temperature stages, such as 50 K and 77 K, using flexible copper braids or anchored thermal straps to minimize parasitic heat load on the cryocooler 306. The horizontal configuration of the HTS coil 302 enables easier integration into beamline structures, NMR consoles, or other systems requiring longitudinal access. To accommodate gravitational constraints in the thermosiphon return line 316, the system may incorporate a slight incline (e.g., 2-5 degrees) or internal wicking structures to support return flow. In compact laboratory systems, the cryocooler 306 may be a two-stage Gifford-McMahon or pulse tube cryocooler rated at 1.0-1.5 W of cooling power at 20-30 K, sufficient to condense neon and maintain stable operation of the magnet. Manifolds surrounding the HTS coil 302 may use evenly spaced, vertically mounted copper or stainless-steel tubes (e.g., 6-10 mm in diameter), thermally bonded to the coil's outer structure and routed to top and bottom fluid distribution headers to ensure uniform cryogen flow and thermal contact. This modular design supports scalability and modular replacement of the coil or thermosiphon subsystems for serviceability and experimental flexibility.

The disclosed system provides several technical solutions to address the challenges associated with cooling a horizontally oriented HTS magnet using a compact liquid neon (LNe) thermosiphon. One primary solution is the use of a passive thermosiphon circuit, which leverages the thermal load from the HTS coil and associated current leads to drive the circulation of liquid neon without the need for mechanical pumps. This eliminates moving parts and simplifies cryogenic operation. To support effective return flow in a horizontal orientation, the system incorporates either a slight positive slope in the return line or internal wicking structures, ensuring reliable gravity-assisted or capillary-driven fluid movement.

The system also addresses the issue of thermal inefficiency by integrating the cryocooler, heat exchanger, and phase separator within a shared, compact vacuum vessel. This arrangement minimizes thermal losses and plumbing complexity while facilitating efficient neon liquefaction. The phase separator itself is designed with a liquid volume of approximately 1 liter but is structurally rated to withstand the pressure of expanded neon gas at room temperature (approximately 30 liters at 300 K), providing a compact yet pressure-compliant cryogenic interface. To achieve uniform cooling of the HTS coil, the system utilizes a manifold configuration with vertically oriented parallel tubes-resembling ribs-connected to top and bottom manifolds. This ensures even distribution and collection of liquid neon around the coil. The current leads are implemented as two parallel high-conductivity rods, such as copper or silver-plated copper, mechanically and electrically connected to the bottom manifold. These leads are cryogenically anchored at intermediate stages, such as 50 K, to reduce heat conduction from ambient temperatures, and are designed to minimize inductance and enable balanced current delivery.

The coil vacuum vessel surrounding the HTS magnet is configured to maintain ultra-high vacuum (UHV) levels, typically in the range of about 10⁻⁶ Torr to about 10⁻⁹ Torr, through the use of cryo-pumping surfaces and/or getter materials. This vacuum environment significantly reduces radiative and conductive heat loads on the coil. The overall system is compact and modular, with the cryocooler designed to fit within the cryostat up to the top flange, enabling integration into applications requiring horizontal access, such as accelerator magnets, NMR systems, or beamline instrumentation. Collectively, these features solve many technical challenges of cryogen circulation, thermal management, pressure containment, and/or spatial efficiency in horizontal HTS cooling systems.

In some embodiments, the coil vacuum vessel may include one or more getter materials configured to maintain ultra-high vacuum (UHV) conditions within the sealed environment surrounding the HTS magnet. These getter materials may be positioned on internal surfaces of the vacuum vessel or integrated within dedicated vacuum ports or baffles. The getter elements function to remove residual gas species that remain after active pumping and to mitigate ongoing outgassing from internal components during operation. In certain embodiments, the getter materials may include non-evaporable getters (NEGs), such as zirconium-based alloys (e.g., Zr—V—Fe or Zr—Al), which are thermally activated prior to or during system cooldown. Upon activation, the NEG surfaces become chemically reactive and adsorb a range of gas species, including hydrogen, oxygen, nitrogen, carbon monoxide, and carbon dioxide. These materials may be provided in the form of coated foils, sintered elements, or cartridges mechanically mounted within the vacuum enclosure.

In other embodiments, evaporable getters such as titanium may be applied to interior surfaces by sublimation or thermal evaporation during initial vacuum processing. These evaporated metal films chemically bind with active gas species to form stable compounds, thereby contributing to vacuum maintenance throughout the operational life of the system. In further embodiments, cryogenic getter surfaces may be used in combination with NEG materials. These surfaces may be thermally anchored to a cryocooler stage or other cryogenic component to maintain temperatures sufficiently low to condense and immobilize condensable gases such as water vapor, hydrocarbons, and carbon dioxide. For example, an interior copper surface cooled below 20 K may function as a cryopump by trapping gases through physisorption and condensation.

The integration of getter materials within the coil vacuum vessel contributes to maintaining vacuum levels in the range of approximately 10⁻⁶ Torr to approximately 10⁻⁹ Torr. In some embodiments, getter systems may be selected and/or dimensioned based on the expected outgassing rate of internal components, vessel volume, and operational duration. These vacuum maintenance strategies are particularly advantageous for superconducting systems operating in sealed or cryogen-free configurations, where long-term vacuum stability is critical to magnet performance and thermal isolation.

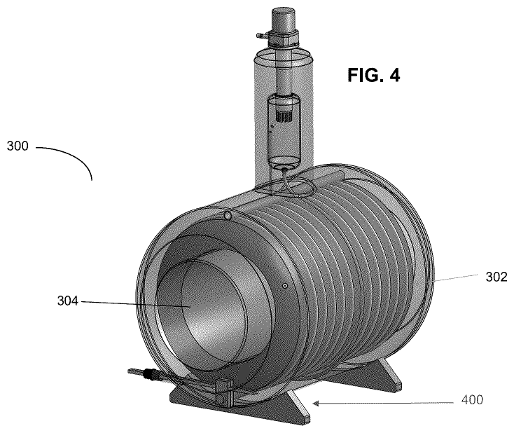

FIG. 4 is a diagram illustrating the compact LNe thermosiphon 300 of FIG. 3 retained by a base support 400 in accordance with some embodiments. The base support 400 is configured to provide mechanical stability, alignment, and vibration isolation for the thermosiphon assembly, particularly during extended cryogenic operation or integration within a larger superconducting system. In some embodiments, the base support 400 may be constructed from low thermal conductivity structural materials, such as G10 fiberglass-reinforced epoxy, PEEK, or thermally insulated stainless steel, to minimize parasitic heat conduction from ambient temperature surfaces to the cryogenic components. The support 400 may include a platform or cradle with precision-machined interfaces that engage with the external surfaces of the phase separator vacuum vessel and associated components of the thermosiphon 300. Clamping brackets, adjustable rails, or vibration-damping mounts may be included to securely retain the thermosiphon while allowing for thermal expansion or contraction during cooldown and operation.

In certain implementations, the base support 400 may incorporate alignment features, such as dowel pins or guide rails, to ensure that the HTS coil and associated plumbing remain properly positioned relative to other subsystems, including the cryocooler, instrumentation leads, or beamline interfaces. The support may be bolted to an optical table, magnet platform, or cryostat base plate, and may include clearance holes or cable channels to accommodate the routing of the LNe supply line, return line, current leads, and sensor wiring.

In one example embodiment, the base support 400 includes a thermally isolated lower platform, supported by vibration isolation mounts such as elastomeric pads or spring-damped feet, with mounting brackets designed to retain a horizontally oriented thermosiphon assembly with a mass of approximately 15 kg to approximately 30 kg. In another example, the base may include integrated thermal intercepts, such as copper braids connected to an intermediate temperature stage, to extract residual heat from structural elements before it reaches the cold stage of the system. The base support 400 not only provides the mechanical integrity of the thermosiphon assembly but also plays a critical role in thermal management, operational alignment, and serviceability of the compact LNe-cooled HTS system.

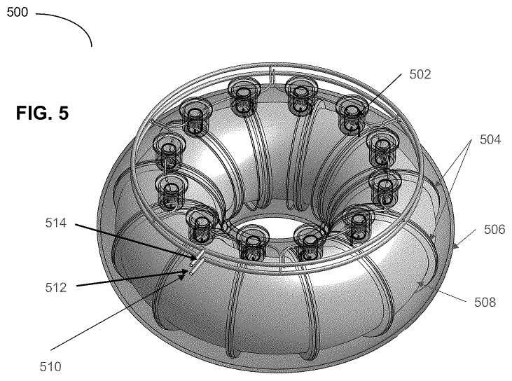

FIG. 5 is a diagram illustrating an example of a compact liquid neon (LNe) thermosiphon system 500 configured for cooling a toroidal HTS magnet array. In some embodiments, the system 500 includes multiple HTS toroidal coils 504 arranged circumferentially within a nested vacuum enclosure comprising an inner vacuum vessel 508 and an outer vacuum vessel 506. Each HTS coil is thermally coupled to a dedicated thermosiphon loop and connected in series electrically to a single power supply, enabling coordinated current flow and magnet synchronization across the toroidal array. Each toroidal HTS coil 504 is integrated with one or more thermosiphon cooling tubes and is outfitted with a local phase separator 502 positioned in proximity to the coil. The phase separator 502 comprises a heat exchanger, a supply line, and a return line, forming an individual thermosiphon circuit. The circulation of liquid neon within each circuit is passively driven by the thermal load originating from the coil windings and associated current leads. The neon vapor generated from the coil region rises to the phase separator, where it is condensed back into liquid by the heat exchanger and subsequently returned to the coil region through gravitational flow or positive return line slope.

In the embodiment shown, each phase separator heat exchanger is coupled to a centralized helium refrigeration loop. Cold helium gas, typically at a temperature of approximately 25 K, is circulated in a closed loop between the refrigerator and the thermosiphon phase separators via a series of helium gas cooling loops 510, 512, and 514. These loops are thermally bonded to the heat exchanger surfaces within the phase separators to extract latent heat from the neon vapor, enabling re-condensation of the neon without direct contact with external cryogens. The helium cooling system may be sized to deliver approximately 100 W of cooling capacity across the array.

The toroidal configuration allows for a highly compact and symmetric magnet architecture, which is particularly advantageous for applications requiring field uniformity or enclosure within cylindrical or annular geometries, such as fusion reactor components, magnetic confinement devices, or high-field NMR systems. The distributed nature of the thermosiphon loops enables independent thermal control and fault tolerance across individual coils. The nested vacuum vessels 506 and 508 are configured to provide high thermal insulation and may incorporate multilayer insulation (MLI), radiation shields, and getter materials to maintain ultra-high vacuum conditions (e.g., about 10⁻⁶ to about 10⁻⁹ Torr) during extended operation. In some implementations, the system may also include thermal intercepts at intermediate stages and diagnostic instrumentation embedded within or adjacent to each coil module, such as temperature sensors, voltage taps, or quench detectors. The modular architecture of the toroidal array supports scalable manufacturing, simplified maintenance, and tailored thermal zoning depending on magnetic field density and duty cycle.

The described system offers technical benefits provided by the systems integrated thermosiphon architecture and distributed coil cooling configuration. By using dedicated liquid neon (LNe) thermosiphon circuits for each HTS toroidal coil, the system achieves passive, pump-free circulation, reducing mechanical complexity and enhancing long-term reliability. Each phase separator is independently cooled by a closed-loop helium refrigeration system, which allows for localized thermal control and efficient neon liquefaction near each coil. This localized re-condensation minimizes the need for extensive cryogen plumbing, reduces pressure drops, and allows the system to scale modularly, supporting a large number of HTS coils within a compact form factor. The nested vacuum vessels with integrated insulation and cryo-pumping surfaces provide high thermal isolation, significantly lowering the thermal load on the refrigeration system and preserving ultra-high vacuum (UHV) levels for prolonged operation.

The toroidal coil configuration further enhances magnetic field uniformity and enables the magnet assembly to conform to space-constrained geometries, such as annular or cylindrical enclosures, which is especially beneficial in fusion energy, compact NMR, or advanced accelerator applications. The ability to connect all HTS coils in series simplifies electrical integration while maintaining uniform current distribution. Additionally, embedding phase separators directly on each coil ensures fast thermal response, improved cryogenic efficiency, and fault tolerance, where an issue in one thermosiphon loop does not compromise the performance of the entire array. These combined solutions deliver a robust, compact, and energy-efficient superconducting magnet platform with low maintenance requirements and suitability for mission-critical or continuous-duty applications.

As noted above, this configuration involves multiple HTS coils housed within a vacuum vessel and connected in series by a single power supply. Each coil is outfitted with a phase separator comprising a heat exchanger and a supply and return line, forming the thermosiphon circuit. The thermal load from the HTS coils and current leads drives this circuit. The neon is liquefied within the phase separators by circulating a closed-loop stream of cold helium gas (with a temperature around 25 K) from a central refrigeration plant through the thermosiphon heat exchangers and back to the refrigeration plant.

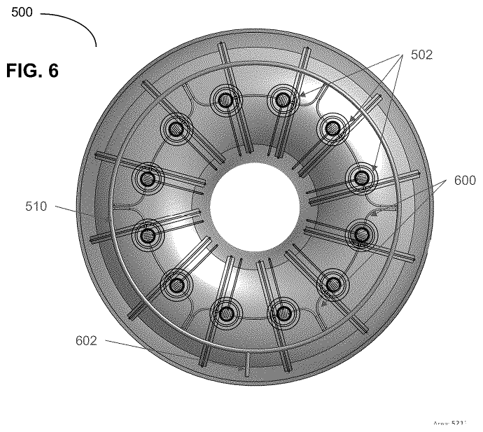

FIG. 6 is a top plan view illustrating a compact liquid neon (LNe) thermosiphon system for cooling a toroidal HTS magnet assembly 500, in accordance with some embodiments of the present disclosure. This view corresponds to the system previously shown in FIG. 5 and provides a clear overhead layout of the thermosiphon-based cooling configuration for multiple toroidal HTS coils.

As illustrated, the system includes multiple HTS coils arranged symmetrically in a circular or toroidal configuration, with each coil equipped with a dedicated phase separator 502. Each phase separator is mounted directly on or adjacent to the respective HTS coil and is configured to condense neon vapor generated within the thermosiphon circuit. The neon is circulated passively within each coil's thermosiphon loop, driven by the thermal load produced by the HTS coil windings and the corresponding magnet current leads. In the embodiment shown, a helium gas cooling circuit 600 is thermally coupled to each pair of adjacent coils. This configuration reduces the total number of helium cooling channels needed, improving system compactness and reducing parasitic thermal load from excess tubing. Each helium gas circuit delivers cold helium gas (e.g., at about 25 K) to the respective phase separators, facilitating neon condensation within the integrated heat exchangers. The returning helium gas is routed back through cooling loops 510, which are connected via a connector 602 to a centralized helium refrigerator providing approximately 100 W of total cooling power across the entire toroidal system.

The top view also highlights the radial symmetry of the thermosiphon and helium loop routing, which supports balanced thermal distribution and minimal spatial interference between components. The coaxial routing of helium lines and neon thermosiphon tubes allows for modular construction and serviceability, while also facilitating thermal isolation through vacuum jacketing or multilayer insulation (MLI) wrapping. This distributed yet coordinated cooling approach provides scalable and fault-tolerant cryogenic performance across the toroidal HTS magnet system. Additionally, the integration of phase separators and helium-cooled heat exchangers in close proximity to the coils ensures localized cryogen recondensation, minimizing thermal resistance and improving cooling efficiency. The system is suitable for applications requiring uniform magnetic field profiles, such as compact fusion magnets, NMR systems, and high-precision magnetic confinement devices.

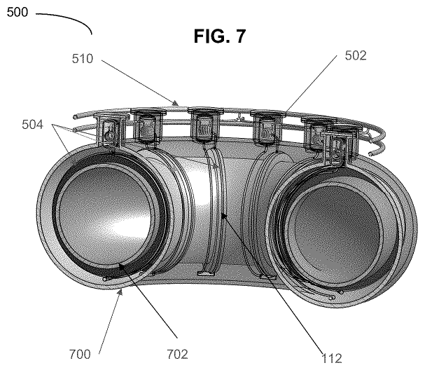

FIG. 7 illustrates a portion of the toroidal HTS magnet system 500, showing additional structural and thermal management details in accordance with some embodiments of the present disclosure. A nested vacuum architecture is implemented by the system and the placement of one or more cooling elements, including the liquid neon (LNe) thermosiphon components and/or helium-based refrigeration subsystems are described. As shown, the system includes a plurality of toroidal HTS coils 504, which are mechanically and thermally supported within a dual-layer vacuum enclosure comprising an outer vacuum vessel 700 and an inner vacuum vessel 702. The inner vacuum vessel 702 is configured to encapsulate the HTS coil windings and associated thermosiphon cooling loops, forming a high-integrity cryogenic environment. The outer vacuum vessel 700 surrounds the inner shell and serves to provide an additional layer of thermal isolation, minimizing radiative and conductive heat transfer from the ambient surroundings.

Each HTS coil 504 is coupled to an individual phase separator 502 located on the upper side of the assembly, where the gravitational and thermal gradients facilitate vapor transport and re-condensation in the thermosiphon circuit. A liquid neon supply line 112 delivers condensed neon from the phase separator 502 to the coil region, where it absorbs heat from the superconducting windings and current leads before returning as vapor. The vapor then rises back to the phase separator to complete the thermosiphon loop. A helium gas cooling circuit 510, part of a closed-loop refrigeration subsystem, is thermally coupled to each phase separator 502. The helium gas, precooled to approximately 25 K via a centralized cryogenic refrigerator, flows through cooling loops attached to the heat exchangers within each phase separator to condense the neon vapor. This indirect cooling architecture allows neon to be liquefied locally at each coil without requiring liquid cryogen transfer across the magnet array.

FIG. 7 also illustrates the compact, modular design of the toroidal system. Each coil section is individually encapsulated yet thermally integrated via the helium loop and power supply configuration. This enables fault tolerance, thermal zoning, and scalable coil deployment. The nested vacuum vessel configuration ensures ultra-high vacuum (UHV) conditions are maintained around the HTS coils, typically in the range of about 10⁻⁶ Torr to about 10⁻⁹ Torr, supporting long-duration cryogenic stability and minimal thermal load on the refrigeration system. This architecture is particularly well suited for advanced magnet applications requiring toroidal geometries, including compact fusion reactors, magnetic confinement systems, and precision diagnostic instruments.

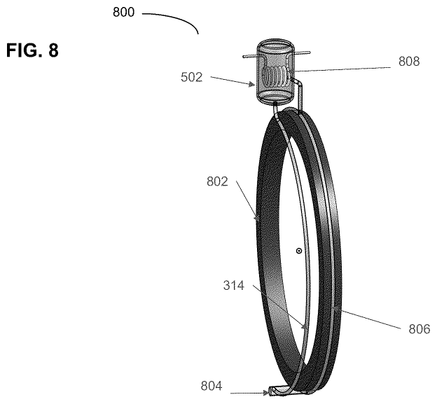

FIG. 8 is a diagram illustrating the toroidal HTS coil and phase separator of the compact LNe thermosiphon for cooling the toroidal HTS magnet system of FIG. 7. FIG. 8 illustrates a toroidal HTS coil with an integrated liquid neon (LNe) thermosiphon and phase separator system 800, in accordance with some embodiments of the present disclosure. The system is configured to provide efficient, passive cryogenic cooling to a toroidal HTS coil 802 by leveraging phase-change thermodynamics within a closed-loop LN e circulation circuit. As shown, the toroidal HTS coil 802 is thermally coupled to a dedicated phase separator 502 positioned above the coil. The phase separator includes an internal helium gas heat exchanger 808, through which pre-cooled helium gas (e.g., at about 25 K) is circulated from a centralized refrigeration unit. This heat exchanger is configured to condense neon vapor back into liquid form, enabling continuous re-liquefaction within the thermosiphon circuit.

A liquid neon (LNe) supply line 314 is routed from the base of the phase separator 502 to the bottom portion of the HTS coil 802. The LNe supply line terminates at a lower manifold 804, which serves as a distribution header to evenly deliver liquid neon along the perimeter or cross-section of the coil. The LN e absorbs thermal energy from the superconducting windings and magnet current leads, transitioning into a two-phase (liquid-vapor) mixture as it moves through the coil structure. The resulting two-phase neon return flow is collected via a return line 806, which is routed from the upper section of the coil back into the phase separator 502. Due to gravitational and thermal gradients, the neon vapor rises naturally into the phase separator, where it is recondensed by the helium-cooled heat exchanger 808, thus completing the thermosiphon loop without the use of mechanical pumps. In some embodiments, the supply and return lines 314 and 806 may be constructed from vacuum-jacketed stainless steel tubing or composite materials to minimize thermal conduction. The phase separator vessel 502 may be designed to accommodate a limited volume of liquid neon (e.g., about 1 liter) while maintaining structural integrity under high internal pressures (e.g., up to 5 MPa) in the event of warm-up and neon gas expansion.

This configuration supports a modular and scalable cooling strategy for toroidal HTS systems, allowing each coil to operate with an independent thermosiphon loop for improved thermal control and system fault tolerance. The use of passive thermosiphon flow reduces system complexity, enhances reliability, and enables integration into compact cryostats with minimal thermal overhead. The described design is beneficial for applications such as compact fusion magnets, magnetic shielding systems, and/or precision imaging environments requiring stable cryogenic performance in toroidal geometries.

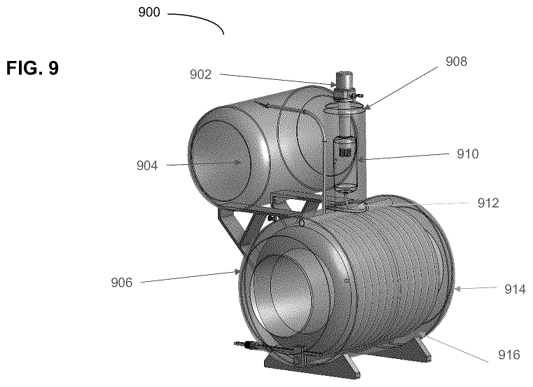

FIG. 9 illustrates Configuration 4: a system 900 for cooling a horizontal HTS coil using a liquid neon (LNe) thermosiphon integrated with a liquid nitrogen (LN₂) cooldown loop, in accordance with some embodiments of the present disclosure. The system is configured to provide efficient thermal management of a horizontally oriented HTS magnet 914, using a combination of cryocooler-assisted liquefaction and gravitational thermosiphon circulation. As noted about, a horizontal HTS coil, phase separator of the compact LNe thermosiphon and LN2 reservoir for accelerated cool down of the HTS magnet system is provided. This configuration utilizes the stored cryogens LN2 and LNe to rapidly bring the magnet to operating temperature. The LN2 volume is based on the size of the coil to bring the temperature from about 300 K to about 80 K. At that point, the LN2 is removed from the LNe volume is sufficient to further reduce the magnet to its operating temperature of 27 K.

A s shown, the system includes a cryocooler 902 thermally coupled to a phase separator vacuum vessel 908. The cryocooler 902 may be a two-stage pulse tube and/or Gifford-McMahon cryocooler capable of reaching base temperatures below 30 K, suitable for liquefying neon. Housed within the vacuum vessel 908 is a phase separator 910, which contains a heat exchanger cooled by the cryocooler and configured to condense neon vapor into liquid form. The phase separator 910 may include an internal reservoir volume of approximately 1-2 liters and be pressure-rated up to 5 MPa to accommodate room-temperature neon gas expansion in the event of system warm-up. A liquid neon supply line 912 extends from the base of the phase separator 910 to the coil vacuum vessel 906, which houses the horizontal HTS coil 914. The supply line 912 delivers condensed neon to the coil region, where it flows through a network of HTS coil cooling lines 916 thermally coupled to the superconducting windings and associated magnet current leads. As the neon absorbs heat, it transitions to a two-phase mixture and passively returns to the phase separator 910, completing the thermosiphon loop without the need for active pumping. The system is designed such that the return line maintains a consistent upward gradient to support gravitational vapor return. To facilitate initial cooldown of the system prior to neon condensation, an LN₂ reservoir 904 is included and thermally linked to the coil vacuum vessel 906. This reservoir may be used to pre-cool the system to below 80 K, thereby reducing the thermal load on the cryocooler and accelerating system readiness. The LN₂ loop may operate as a temporary thermosiphon or flow loop, optionally vented or recovered once neon cooling is initiated.

The horizontal orientation of the HTS coil 914 enables compatibility with including, but not limited to, beamline systems, imaging platforms, and/or accelerator infrastructure that require lateral or longitudinal magnet access. The vacuum enclosure 906 may include multilayer insulation (MLI) and be equipped with pressure-relief ports, instrumentation feedthroughs, and thermal intercepts to maintain ultra-high vacuum (UHV) conditions and reduce thermal conduction. This hybrid LNe/LN₂ cooling configuration provides a modular, compact, and energy-efficient cryogenic platform for HTS magnet applications, particularly those requiring horizontal geometry, passive cooling loops, and rapid thermal conditioning via LN₂ pre-cooling.

### Examples

Clause 1. A liquid neon thermosiphon system for cooling a HTS magnet, comprising: a phase separator vacuum vessel, comprising: a cryocooler; a heat exchanger thermally coupled to the cryocooler; and a phase separator configured to receive neon vapor and condense it into liquid neon; and a thermosiphon circuit configured to circulate liquid neon, driven by a thermal load from one or more HTS coils and associated current leads, the thermosiphon circuit comprising: a liquid neon (LNe) supply line; a coil cooling line; and a return line configured to direct vaporized neon to the phase separator.

Clause 2. The system of clause 1 wherein the HTS magnet is vertically oriented and enclosed in a vacuum vessel positioned below the phase separator to enable gravity-assisted circulation.

Clause 3. The system of clause 1, wherein the HTS magnet is horizontally oriented and the return line is configured with a positive slope or wicking structures to facilitate vapor return.

4. The system of claim 1, further comprising a vacuum-insulated coil vessel with a vacuum level between approximately 10⁻⁶ Torr and approximately 10⁻⁹ Torr.

Clause 5. The system of clause 4, wherein the vacuum-insulated coil vessel comprises one or more getter materials selected from non-evaporable getters (NEGs), evaporable metal coatings, or cryogenic surfaces to maintain vacuum conditions.

Clause 6. The system of clause 1, wherein the thermosiphon circuit is configured to operate with two-phase neon between approximately 25 K and 30 K.

Clause 7. The system of clause 1, further comprising thermal intercepts thermally anchored at intermediate temperature stages along current leads to reduce parasitic heat load.

Clause 8. The system of clause 1, wherein the coil cooling line comprises parallel tubes connected between upper and lower manifolds to ensure uniform liquid distribution around the HTS coil.

Clause 9. The system of clause 1, wherein the phase separator vacuum vessel has an internal volume of approximately 3 liters to approximately 5 liters and is pressure-rated up to about 5 MPa to accommodate neon gas expansion at about 300 K.

Clause 10. A toroidal LNe thermosiphon system for cooling a toroidal HTS magnet assembly, comprising: a plurality of HTS coils arranged circumferentially within a vacuum enclosure; a plurality of phase separators, each associated with a respective HTS coil and comprising: a helium-cooled heat exchanger; and a local neon phase separator; a centralized helium gas refrigerator configured to deliver helium gas at approximately 25 K to the heat exchanger; and for each HTS coil, a thermosiphon circuit comprising: a liquid neon supply line; a coil cooling line; and a return line directed to an associated phase separator.

Clause 11. The system of clause 10, wherein each of the plurality of HTS coils are electrically connected in series to a single power supply.

Clause 12. The system of clause 10, wherein the toroidal coils are enclosed within nested inner and outer vacuum vessels and supported by a modular cryostat structure.

Clause 13. The system of clause 10, wherein each helium cooling loop is shared by two adjacent coils to reduce system complexity and helium line redundancy.

Clause 14. The system of clause 10, further comprising embedded instrumentation in the vacuum enclosure, including temperature sensors, vacuum gauges, and quench detectors.

Clause 15. A base-mounted LNe thermosiphon system for a horizontal HTS magnet, comprising: a horizontal HTS coil enclosed within a vacuum vessel; a cryocooler mounted on a support structure; a phase separator vacuum vessel thermally coupled to the cryocooler; a liquid neon thermosiphon circuit connecting the phase separator to the coil; and a base support configured provide vibration isolation and mechanical alignment between the phase separator vacuum vessel, the cryocooler, and the horizontal HTS coil.

Clause 16. The system of clause 15, wherein the base support comprises vibration-damping mounts and thermal intercepts coupled to intermediate cooling stages.

Clause 17. The system of clause 15, wherein the support structure includes thermal shielding, cable routing openings, and anchoring features for alignment with external systems.

Clause 18. A hybrid HTS magnet cooling system, comprising: a liquid nitrogen (LN₂) subsystem comprising a reservoir thermally coupled to an HTS coil, the LN₂ subsystem configured to precool the HTS magnet from approximately 300 K to approximately 80 K; a liquid neon (LNe) thermosiphon system comprising: a phase separator vacuum vessel including a cryocooler, a heat exchanger, and a liquid neon phase separator of sufficient volume to cool the HTS magnet from approximately 80 K to approximately 20 K; and a thermosiphon circuit driven by a thermal load from the HTS coil and associated current leads, the thermosiphon circuit comprising a liquid neon supply line and a plurality of parallel coil cooling lines.

Clause 19. The system of clause 18, wherein the LN₂ subsystem operates as a temporary thermosiphon circuit or flow loop prior to neon activation.

Clause 20. The system of clause 18, wherein the volume of the LN₂ reservoir is selected based on one or more thermal properties of the HTS coil, including a thermal mass of the HTS coil and a total enthalpy required to reduce a temperature of the HTS coil from approximately 300 K to approximately 80 K.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A liquid neon thermosiphon system for cooling a high-temperature superconducting (HTS) magnet, comprising:
a phase separator vacuum vessel, comprising:
a cryocooler;
a heat exchanger thermally coupled to the cryocooler; and
a phase separator configured to receive neon vapor and condense it into liquid neon; and
a thermosiphon circuit configured to circulate liquid neon, driven by a thermal load from one or more HTS coils and associated current leads, the thermosiphon circuit comprising:
a liquid neon (LNe) supply line;
a coil cooling line; and
a return line configured to direct vaporized neon to the phase separator.

2. The system of claim 1 wherein the HTS magnet is vertically oriented and enclosed in a vacuum vessel positioned below the phase separator to enable gravity-assisted circulation.

3. The system of claim 1, wherein the HTS magnet is horizontally oriented and the return line is configured with a positive slope or wicking structures to facilitate vapor return.

4. The system of claim 1, further comprising a vacuum-insulated coil vessel with a vacuum level between approximately 10⁻⁶ Torr and approximately 10⁻⁹ Torr.

5. The system of claim 4, wherein the vacuum-insulated coil vessel comprises one or more getter materials selected from non-evaporable getters (NEGs), evaporable metal coatings, or cryogenic surfaces to maintain vacuum conditions.

6. The system of claim 1, wherein the thermosiphon circuit is configured to operate with two-phase neon between approximately 25 K and 30 K.

7. The system of claim 1, further comprising thermal intercepts thermally anchored at intermediate temperature stages along current leads to reduce parasitic heat load.

8. The system of claim 1, wherein the coil cooling line comprises parallel tubes connected between upper and lower manifolds to ensure uniform liquid distribution around the HTS coil.

9. The system of claim 1, wherein the phase separator vacuum vessel has an internal volume of approximately 3 liters to approximately 5 liters and is pressure-rated up to about 5 MPa to accommodate neon gas expansion at about 300 K.

10. A toroidal LNe thermosiphon system for cooling a toroidal high-temperature superconducting (HTS) magnet assembly, comprising:
a plurality of HTS coils arranged circumferentially within a vacuum enclosure;
a plurality of phase separators, each associated with a respective HTS coil and comprising:
a helium-cooled heat exchanger; and
a local neon phase separator;
a centralized helium gas refrigerator configured to deliver helium gas at approximately 25 K to the heat exchanger; and
for each HTS coil, a thermosiphon circuit comprising:
a liquid neon supply line;
a coil cooling line; and
a return line directed to an associated phase separator.

11. The system of claim 10, wherein each of the plurality of HTS coils are electrically connected in series to a single power supply.

12. The system of claim 10, wherein the toroidal coils are enclosed within nested inner and outer vacuum vessels and supported by a modular cryostat structure.

13. The system of claim 10, wherein each helium cooling loop is shared by two adjacent coils to reduce system complexity and helium line redundancy.

14. The system of claim 10, further comprising embedded instrumentation in the vacuum enclosure, including temperature sensors, vacuum gauges, and quench detectors.

15. A base-mounted LNe thermosiphon system for a horizontal high-temperature superconducting (HTS) magnet, comprising:
a horizontal HTS coil enclosed within a vacuum vessel;
a cryocooler mounted on a support structure;
a phase separator vacuum vessel thermally coupled to the cryocooler;
a liquid neon thermosiphon circuit connecting the phase separator to the coil; and
a base support configured provide vibration isolation and mechanical alignment between the phase separator vacuum vessel, the cryocooler, and the horizontal HTS coil.

16. The system of claim 15, wherein the base support comprises vibration-damping mounts and thermal intercepts coupled to intermediate cooling stages.

17. The system of claim 15, wherein the support structure includes thermal shielding, cable routing openings, and anchoring features for alignment with external systems.

18. A hybrid high-temperature superconducting (HTS) magnet cooling system, comprising:
a liquid nitrogen (LN₂) subsystem comprising a reservoir thermally coupled to an HTS coil, the LN₂ subsystem configured to precool the HTS magnet from approximately 300 K to approximately 80 K;
a liquid neon (LNe) thermosiphon system comprising:
a phase separator vacuum vessel including a cryocooler, a heat exchanger, and
a liquid neon phase separator of sufficient volume to cool the HTS magnet from approximately 80 K to approximately 20 K; and
a thermosiphon circuit driven by a thermal load from the HTS coil and associated current leads, the thermosiphon circuit comprising a liquid neon supply line and a plurality of parallel coil cooling lines.

19. The system of claim 18, wherein the LN₂ subsystem operates as a temporary thermosiphon circuit or flow loop prior to neon activation.

20. The system of claim 18, wherein the volume of the LN₂ reservoir is selected based on one or more thermal properties of the HTS coil, including a thermal mass of the HTS coil and a total enthalpy required to reduce a temperature of the HTS coil from approximately 300 K to approximately 80 K.
